(19) United States
(12) Patent Application Publication
(10) Pub. No.: US 2023/0031163 A1
(43) Pub. Date: Feb. 2, 2023

(54) OPTIMIZATION ENGINE, OPTIMIZATION METHOD, AND PROGRAM

(71) Applicant: NIPPON TELEGRAPH AND TELEPHONE CORPORATION, Tokyo (JP)

(72) Inventors: Hiroya ONO, Musashino-shi, Tokyo (JP); Satoshi NARIKAWA, Musashino-shi, Tokyo (JP)

(73) Assignee: NIPPON TELEGRAPH AND TELEPHONE CORPORATION, Tokyo (JP)

(21) Appl. No.: 17/791,174

(22) PCT Filed: Jan. 22, 2020
(86) PCT No.: PCT/JP2020/002154

§ 371 Date: Jul. 6, 2022

(51) Int. Cl. H04W 48/18; H04W 24/02; H04W 76/10

(52) U.S. Cl. CPC H04W 48/18; H04W 24/02; H04W 76/10

(57) ABSTRACT

An object of the present invention is to provide an optimization engine, an optimization method, and a program that have excellent extensibility, facilitate effective use of unique characteristics of each access network, and can enhance satisfaction levels of diverse users. An optimization engine according to the present invention includes an objective function of an item intended to be improved, collects parameters from access networks and terminals, and finds a combination of connection destinations that maximizes or minimizes the objective function. By appropriately configuring the objective function, it is possible to control user satisfaction levels, bandwidth utilization rates, costs for use of circuits, and the like.

### TECHNICAL FIELD

The present disclosure relates to an optimization engine, an optimization method, and a program that select optimal ones from among a plurality of access networks.

### BACKGROUND ART

When a user uses a network service, the user uses a telecommunication circuit provided by a telecommunication carrier in some cases. For usable circuits, there are various physical media, such as optical circuits and wireless communication circuits. For example, for the optical circuits, telecommunications standards such as IEEE 802.3 (Ethernet(R)) and ITU-T G.983/G.984/G.987/G.989 exist. For the wireless communication circuits, telecommunications standards such as 3GPP 36 Series (LTE), IEEE 802.11 (wireless LAN), and IEEE 802.16 (WiMAX) exist.

A user terminal can perform communication by selectively using a plurality of different telecommunications standards. For example, in a case of a smartphone, a user can select which one of LTE, wireless LAN, and Bluetooth(R) to use. Moreover, circuits of different types of carriers using the same telecommunications standard can also be selectively used.

Since each access network offers different communication quality including a bandwidth, a delay, and the like, such access networks need to be selectively used as appropriate according to a purpose of use. As shown in FIG. 1, a user can manually switch access networks to use, by changing settings on a user terminal. However, when many accessible networks exist, a difficulty arises that a user needs to understand characteristics of each access network and then manually make appropriate settings for selecting an access network.

If a user terminal is connected to an access network that offers communication quality undesirable to a user or that is not suitable for a purpose, communication quality for other user terminals that use the access network is also lowered. As described above, effective use of communication resources in an entire network system possibly cannot be achieved.

For example, in the case of connection to an access network that offers communication quality undesirable to the user, a following situation may occur.

When an attempt is made to use an access network with insufficient radio field strength such as a public wireless LAN in a station or the like, since the number of modulation levels decreases, more communication resources such as time and frequency need to be allocated to the user. In other words, communication quality for other users is greatly degraded, due to the allocation of the communication resources.

In the case of connection to an access network that is not suitable for a purpose of the user, a following situation may occur.

It is assumed that a network (a) with a small total bandwidth but low latency exists. When the user using an application that does not require low latency, such as viewing a video, uses much of the bandwidth of the network (a), a delay increases in communication for a user using an application that requires low latency such as an online game, resulting in a satisfaction level being lowered. In other words, connection to an access network that is not suitable for a purpose may lead to lowering the satisfaction level of another user in some cases.

To overcome the above difficulties, it has been known that a user terminal includes a function of automatically selecting an access network (for example, see Patent Literature 1). The function is a function of predicting communication quality based on a radio field strength or the like of an accessible wireless LAN circuit and preferentially connecting to the wireless LAN circuit when the wireless LAN circuit is expected to ensure sufficient quality and is also accessible.

Such a function estimates communication quality from wireless access information. Accordingly, an error may occur between an estimated value and actual communication quality in some cases, depending on a degree of congestion in a higher-level network and behavior of other user terminals. A problem is addressed that in order to acquire the actual communication quality, it is necessary to connect to a circuit of interest once and measure quality.

Moreover, with the function, since a connection destination of another user terminal cannot be controlled, another problem is also addressed that network optimization in an entire system is difficult. For example, a case is considered in which while a user 1 wants to use an application that requires low-latency communication, a network 2 capable of low-latency communication is already occupied by a terminal of a user 2 who is using an application with a less demanding latency requirement. In such a case, a delay occurs in communication for the user 1, and it is difficult to achieve a satisfaction level of the user 1. On the other hand, communication for the user 2 is in a state of excessive quality. As described above, with the function of Patent Literature 1, service optimization is difficult.

To solve the problems with Patent Literature 1 (to optimize an entire network system), there is a scheme in which a server or a base station device on a network indicates a connection destination to a user terminal (for example, see Non-Patent Literature 1). FIG. 3 is a diagram describing the scheme of Non-Patent Literature 1. When the scheme is used, since connection destinations of a plurality of users can be collectively controlled with a degree of congestion in an entire network taken into consideration, optimization of all users can be realized with accuracy. Non-Patent Literature 1 can enhance throughput of an entire system in an environment in which a 3GPP circuit and a wireless LAN circuit coexist.

### Citation List

### Patent Literature

Patent Literature 1: Japanese Patent Laid-Open No. 2012-169971

### Non-Patent Literature

Non-Patent Literature 1: D. Kimura, “A Novel RAT Virtualization System with Network-Initiated RAT Selection Between LTE and WLAN”, 978-1-5090-4183-1/17, 2017 IEEE

Non-Patent Literature 2: Hiroya Ono, Satoshi Narikawa, “Proposal of automatic optimal access selection scheme adaptive to a multi-access environment”, 2019 IEICE Society Conference, B-6-36

Non-Patent Literature 3: https://business.ntt-east.co.jp/service/azukeru_ms/, retrieved on Dec. 31, 2019

Non-Patent Literature 4: https://www.ntt.com/business/services/application/mail-groupware/office365.html, retrieved on Dec. 31, 2019

### SUMMARY OF THE INVENTION

### Technical Problem

The network-initiated connection destination selection algorithm of Non-Patent Literature 1 is an either-or algorithm for switching between LTE and wireless LAN and the like. In other words, Non-Patent Literature 1 has a first problem that it is difficult to extend to environments in which more various types of access networks are accessible.

The selection algorithm of Non-Patent Literature 1 also has a second problem that an objective function for optimization involves only a throughput variable, and it is difficult to enhance a level of user satisfaction with an application that places importance on an indicator other than throughput. In recent years, applications have appeared with which satisfaction levels are greatly affected by delays and fluctuations in delay, and the connection destination selection scheme that takes only throughput into consideration cannot sufficiently enhance user satisfaction levels.

Moreover, each telecommunications standard has a physical property that is determined by radio frequency or the like, as well as unique features that are determined by a service form such as a cost. The selection algorithm of Non-Patent Literature 1 does not take such features into consideration, and selects a connection destination without reflecting characteristics of each access network. In other words, Non-Patent Literature 1 has a third problem that connection destination selection taking characteristics of each access network into consideration is impossible, and in this respect, user satisfaction levels cannot be sufficiently enhanced either.

As means for solving the three problems described above, a scheme is disclosed that optimizes an access destination of a user based on a utility function defined with a plurality of communication quality parameters and a feature of each access method factored in (see Non-Patent Literature 2).

On another front, although conventional data communications were centered on Internet communication, cloud services have been widespread, and low-latency applications have been requested in recent years. To respond to such requests, cases have emerged in which an application server is installed in a network of a telecommunication carrier and is provided, together with a telecommunication circuit, as a service (for example, see Non-Patent Literatures 2, 3). Such cases require that use of the application or reception of the service should be restricted to a network, or connection should be made to a specific network in order to enhance quality of experience of the application.

However, Patent Literature 1 and Non-Patent Literatures 1, 2 are schemes for optimizing a communication path from a higher-level network to the Internet, and do not take into consideration the above-described (1) application that can be used only in coverage of the specific network, and (2) application of which quality of experience is enhanced in coverage of the specific network. Accordingly, Patent Literature 1 and Non-Patent Literatures 1, 2 have a problem that connection is not always made to an access path desired by a user who intends to use any one of the above-described applications.

Accordingly, to solve the problems, an object of the present invention is to provide an optimization engine, an optimization method, and a program that can improve accuracy in selection of a network suitable for an application, and can enhance quality of experience, without making major alterations to a communication system.

### Means for Solving the Problem

To achieve the object, an optimization engine according to the present invention includes an objective function of an item desired to be improved, and is configured to collect parameters from access networks and terminals, and to find a combination of connection destinations that maximizes or minimizes the objective function, taking into consideration a fact that a communication-destination server is installed in a specific access network.

Specifically, an optimization engine according to the present invention is an optimization engine in a communication system, the communication system having a configuration in which each of a plurality of terminals connects to a higher-level network via any one of a plurality of access networks,

the optimization engine including:
an information collection unit that collects, from each of the access networks, communication quality information and a network feature, and collects, from each of the terminals, accessibility information indicating which of the access networks is accessible;
a candidate selection unit that generates, based on the accessibility information, connection destination candidates that are candidates for the access networks to which the terminals respectively connect;
a quality estimation unit that estimates, based on the communication quality information, communication quality with respect to the connection destination candidates to obtain estimated communication quality; and
a determination unit that determines optimal connection destinations from among the connection destination candidates, based on a calculated value obtained by substituting the network feature and the estimated communication quality into a preconfigured objective function,
wherein in a case where there is a correspondence between an application and a specific access network over which the application can be implemented among the access networks,
the quality estimation unit, when predicting the communication quality, performs processing that causes a difference in the communication quality between when the terminal uses the application over the specific access network and when the terminal uses the application over the other access networks.

An optimization method according to the present invention is an optimization method for a communication system,

the communication system having a configuration in which each of a plurality of terminals connects to a higher-level network via any one of a plurality of access networks,

the optimization method including:
collecting, from each of the access networks, communication quality information and a network feature, and collecting, from each of the terminals, accessibility information indicating which of the access networks is accessible;
generating, based on the accessibility information, connection destination candidates that are candidates for the access networks to which the terminals respectively connect;
estimating, based on the communication quality information, communication quality with respect to the connection destination candidates to obtain estimated communication quality; and
determining optimal connection destinations from among the connection destination candidates, based on a calculated value obtained by substituting the network feature and the estimated communication quality into a preconfigured objective function,
wherein in a case where there is a correspondence between an application and a specific access network over which the application can be implemented among the access networks,
when the communication quality is predicted, processing is performed that causes a difference in the communication quality between when the terminal uses the application over the specific access network and when the terminal uses the application over the other access networks.

In the present optimization engine and the method for the optimization engine, a combination of connection destinations is selected from among the plurality of access networks, based on the objective function using a plurality of the communication quality parameters and a plurality of the network features as variables. By appropriately configuring the objective function, it is possible to control bandwidth utilization rates, costs for use of circuits, and the like. Connection destinations of the user terminals can be derived according to the arbitrarily configured objective function, by using values that can be acquired from network devices and the user terminals, or values that can be derived from such values.

In the present optimization engine and the method for the optimization engine, when the communication quality for use in the objective function is estimated, the communication quality is estimated by using a network simulator, or based on settings of a network device. At the time, simulative settings are made on the network device such that the calculated value varies between when access is gained to a specific server via an access network to which the specific server is connected and when access is gained to the server via the other access networks.

Accordingly, the present invention can provide the optimization engine and the optimization method that can improve accuracy in selection of a network suitable for an application, and can enhance quality of experience, without making major alterations to the communication system.

For example, it can be determined that the optimal connection destinations are the connection destination candidates that give a maximum value or a minimum value of the objective function.

The optimization engine according to the present invention further includes a notification unit that outputs a connection instruction to each of the terminals and each of the access networks such that connections between the terminals and the access networks match the optimal connection destinations.

The optimization method according to the present invention further includes outputting a connection instruction to each of the terminals and each of the access networks such that connections between the terminals and the access networks match the optimal connection destinations.

A program according to the present invention is a program for causing a computer to function as the optimization engine. The optimization engine according to the present invention can be implemented by the computer and the program, and the program can be recorded in a recording medium, and can also be provided through a network.

### Effects of the Invention

The present invention can provide an optimization engine, an optimization method, and a program that can improve accuracy in selection of a network suitable for an application, and can enhance quality of experience, without making major alterations to a communication system.

### BRIEF DESCRIPTION OF DRAWINGS

FIG. 1 is a diagram describing a communication system related to the present invention.

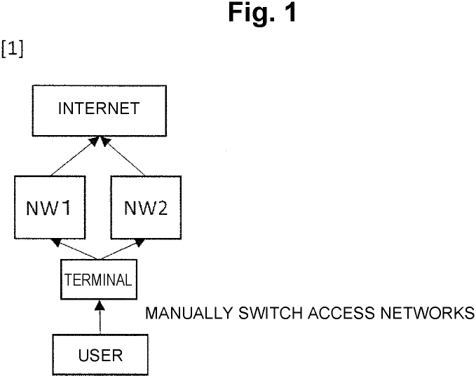

FIG. 2 is a diagram describing a communication system related to the present invention.

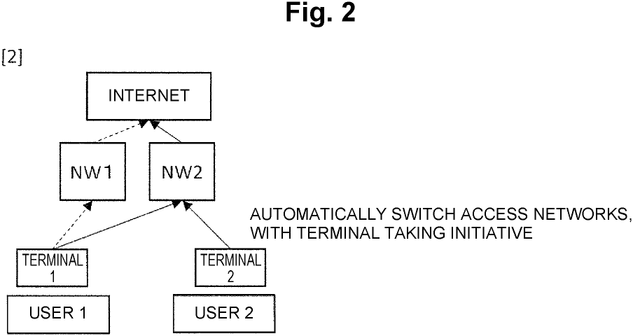

FIG. 3 is a diagram describing a communication system related to the present invention.

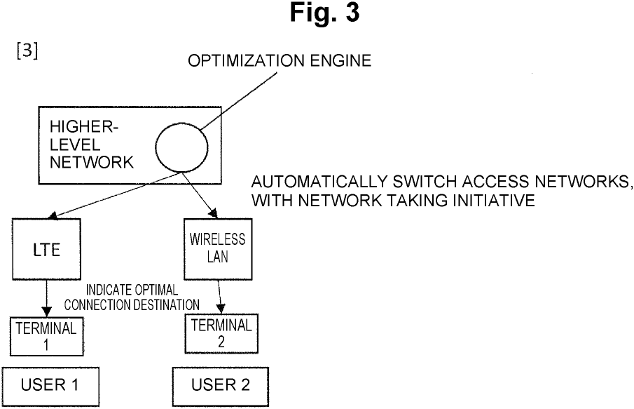

FIG. 4 is a diagram describing a communication system including an optimization engine according to the present invention.

FIG. 5 is a diagram describing the communication system including the optimization engine according to the present invention.

FIG. 6 is a diagram describing the communication system including the optimization engine according to the present invention.

FIG. 7 is a diagram describing operation of the optimization engine according to the present invention.

FIG. 8 is a diagram describing operation of the communication system including the optimization engine according to the present invention.

FIG. 9 is a diagram describing operation of the communication system including the optimization engine according to the present invention.

FIG. 10 is a diagram describing a communication system including an optimization engine according to the present invention.

FIG. 11 is a diagram describing the optimization engine according to the present invention.

### DESCRIPTION OF EMBODIMENTS

Embodiments of the present invention will be described with reference to the accompanying drawings. The embodiments described below are examples of carrying out the present invention, and the present invention is not limited to the embodiments below. Note that constituent elements denoted by the same reference signs in the description and the drawings are assumed to be constituent elements that are mutually identical.

### Embodiment 1

### Communication System

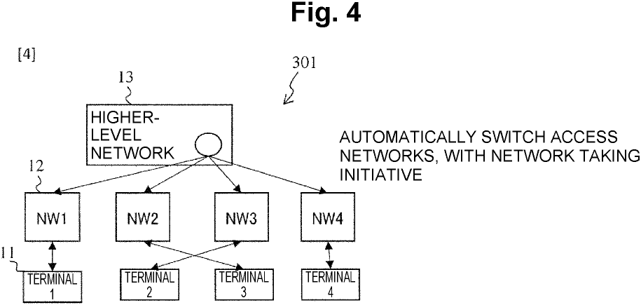

FIG. 4 is a diagram describing a communication system 301 including an optimization engine 50 according to the present embodiment. The communication system 301 has a configuration in which each of a plurality of terminals 11 is connected to a higher-level network 13 via any one of a plurality of access networks (NWs) 12. Although both the terminals 11 and the NWs 12 are four in number in the communication system 301 in FIG. 4, the numbers are not limited to four.

The optimization engine 50 dynamically selects, from among the plurality of NWs 12, a combination of connections that connect the terminals 11 and NWs 12, by calculating an objective function such as a user satisfaction level function that takes a plurality of communication quality parameters and a plurality of network features as variables. Note that “dynamically select” implies periodically calculating the objective function and changing combinations of connections according to a result of the calculation.

The communication quality parameters are parameters related to a total bandwidth, a delay, fluctuations in delay, the number of available TCP sessions, the number of available IP addresses, and other communication quality of a NW.

The network features are values indicating a cost for use of a circuit, user mobility robustness (mobility), presence or absence of encryption, and other network characteristics.

If the communication quality parameters and the network features are values that can be acquired from a network device and a user terminal, or values that can be derived from such values, an NW 12 that each terminal 11 should be connected to is derived according to the arbitrarily configured objective function.

The optimization engine 50 can bring about effects as follows.
(1) In an environment where many NWs 12 exist, an appropriate NW 12 to be used by each terminal 11 can be selected.
(2) When the number of accessible NWs 12 increases, a connection destination selection algorithm can be easily extended.
(3) For an application with which a satisfaction level is associated with a plurality of parameters other than throughput, a terminal 11 can select an NW 12 that makes the satisfaction level higher.
(4) Connections can be made between the terminals 11 and NWs 12, with characteristics of each NW
(5) Through design of the objective function, connections between the terminals 11 and NWs 12 can be realized that respond to diverse requests, such as maximizing user satisfaction levels, and balancing individual network load factors. In other words, by configuring the objective function as desired in the optimization engine 50, the entire communication system 301 can be controlled, with a bandwidth utilization rate, a cost for use of the circuit, and the like of each NW 12 taken into consideration.

### Supplement

The “connection destination selection algorithm” refers to a sequential procedure for selecting a connection destination that is a NW to be selected by each user terminal (repeated execution of a procedure including selection of search candidates, quality estimation, and evaluation of the objective function (search loop), after a procedure for configuring the objective function, which will be described later).

The “connection destination selection algorithm can be easily extended” implies that changes in type and number of accessible NWs or a change in number of terminals can be handled only by mainly extending functionality of the quality estimation unit, without needing to change the above-described sequential procedure or the objective function. The reason why the “connection destination selection algorithm can be easily extended” is because each of functional units of configuring an objective function, selecting search candidates, estimating quality, and evaluating the objective function, which will be described later, has a high degree of independence, and functionality extension is easy. In other words, when the number of accessible NWs increases, the increase can be handled only by changing part of the functionality, without needing to greatly change the objective function or a flowchart.

Note that many of conventional connection destination selection algorithms are either-or schemes that select one of a 3GPP circuit and a wireless LAN circuit as in Non-Patent Literature 1, and major alterations in or renewal of an algorithm is needed in order for the algorithm to be applied to three or more NWs. Moreover, in many of such schemes, characteristics of and a relation between the 3GPP circuit and the wireless LAN circuit are reflected directly in a function of selecting a connection destination (a dedicated design is made that selects one of two options, the 3GPP circuit and the wireless LAN circuit), and to introduce a new NW, a function of selecting a connection destination needs to be reconstructed.

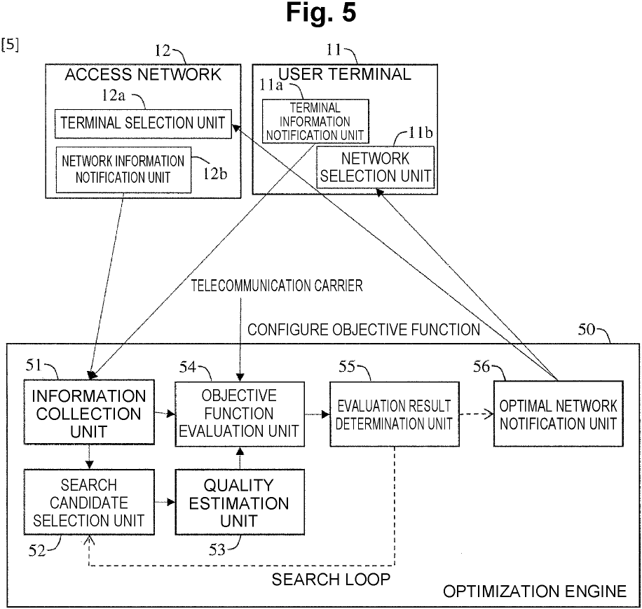

FIG. 5 is a block diagram describing functions of the terminals 11, the access networks 12, and the optimization engine 50.

Each terminal 11 has a terminal information notification unit 11a that notifies an application to use and accessible NWs 12 to the optimization engine 50.

Each terminal 11 has a network selection unit 11b that switches NWs 12 to use, according to an instruction from the optimization engine 50.

Each NW 12 has a terminal selection unit 12a that switches terminals 11 to connect to, according to an instruction from the optimization engine 50. Note that any one of the terminal selection unit 12a of each NW 12 and the network selection unit 11b of each terminal 11 may be used, or both may be used at the same time.

Each NW 12 has a network information notification unit 12b that notifies own communication quality information, such as an available bandwidth, to the optimization engine 50.

The optimization engine 50 has an information collection unit 51 that collects information from the information notification unit 11a of each terminal 11 and the network information notification unit 12b of each NW 12.

The optimization engine 50 has a search candidate selection unit 52 that defines a set of combinations of connections between the terminals 11 and NWs 12, and extracts, from the set, a candidate combination of connections used at a time of search.

The optimization engine 50 has a quality estimation unit 53 that simulates or estimates quality by simulating an actual world. The quality estimation unit 53 receives the candidate combination of connections as an input and outputs estimated quality achieved at each terminal 11 when such connections are made.

The optimization engine 50 has an objective function evaluation unit 54 that calculates a value of the objective function, based on communication quality or the like of each terminal 11.

The optimization engine 50 has an evaluation result determination unit 55 that receives a result of the calculation by the objective function evaluation unit 54, and determines whether to perform again or to finish search for a combination of connections.

The optimization engine 50 has an optimal network notification unit 56 that notifies a combination of connections ultimately determined to at least one of each terminal 11 and each NW 12.

In the optimization engine 50,
the information collection unit 51 collects, from each NW 12, communication quality information (undermentioned “P”) and network features (undermentioned “C”), and collects, from each terminal 11, accessibility information (undermentioned “A”) indicating which NW 12 is accessible;
the search candidate selection unit 52 generates, based on the accessibility information, connection destination candidates (a combination of connections) that are candidates for NWs 12 to which the terminals 11 respectively connect;
the quality estimation unit 53 estimates communication quality (outputs estimated communication quality) with respect to the connection destination candidates, based on the communication quality information;
the objective function evaluation unit 54 substitutes the network features and the estimated communication quality into a preconfigured objective function; and
the evaluation result determination unit 55 determines that the connection destination candidates that give a maximum value or a minimum value of the objective function are optimal connection destinations.

Then, the optimal network notification unit 56 outputs a connection instruction to at least one of each terminal 11 and each NW 12 such that connections between the terminals 11 and the NWs 12 match the optimal connection destinations.

### Operation

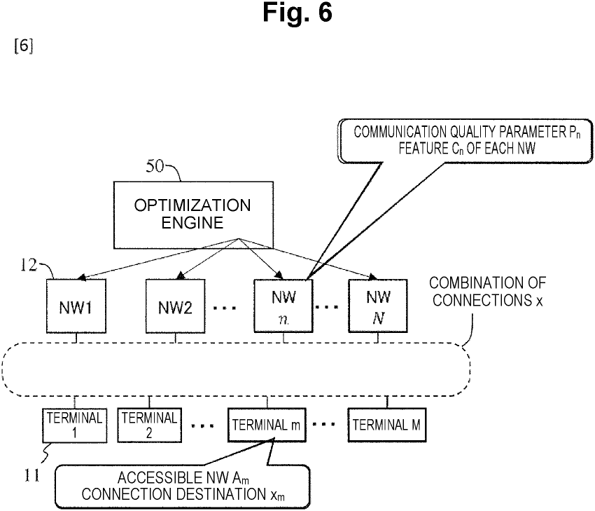

FIG. 6 is a diagram describing operation of the optimization engine 50. It is assumed that each terminal 11 can use N types of NWs 12 at the maximum within the communication system. It is assumed that an array of values of communication quality parameters, such as a total bandwidth and an average delay, of an n-th NW 12 is represented by a vector Pₙ. Moreover, it is assumed that an array of features of the n-th NW 12, other than the communication quality, is represented by a vector Cₙ.

The numbers of elements of the vector Pₙ and the vector Cₙ are equal to the numbers of communication quality parameters and features taken into consideration, respectively. Further, it is assumed that a set of vectors Pₙ is a set P, and that a set of vectors Cₙ is a set C.

$$\begin{matrix}P = \left\{{P}_{n} \left|1 \leq n \leq N\right)\right\} \\ C = \left\{{C}_{n} \left|1 \leq n \leq N\right)\right\}\end{matrix}$$

Note that the vector Cₙ may include a list of an application that can be implemented within the n-th NW 12.

M terminals 11 are present within the communication system. It is assumed that an array indicating NWs 12 accessible to an m-th terminal 11 is a vector Aₘ, and that a set of vectors Aₘ is a set A. Numbers for the accessible NWs 12 are described in the vector Aₘ, and the number of elements of the vector Aₘ is equal to the number of the accessible NWs 12. Alternatively, the vector Aₘ may be defined by an array with N elements in which an i-th component “A_{m,i}” of the vector Aₘ is represented by a following expression.

$${A}_{m . i} = \left\{\begin{matrix}\text{0} & \text{if} & \text{i-th} & \text{access} & \text{network} & \text{is} & \text{inassessible} \\ \text{1} & \text{if} & \text{i-th} & \text{access} & \text{network} & \text{is} & \text{accessable}\end{matrix}\right)$$

$$A = \left[{A}_{m} \left|1 \leq m \leq M\right)\right]$$

Note that the vector Am may include information on an application that the m-th terminal 11 uses (application information).

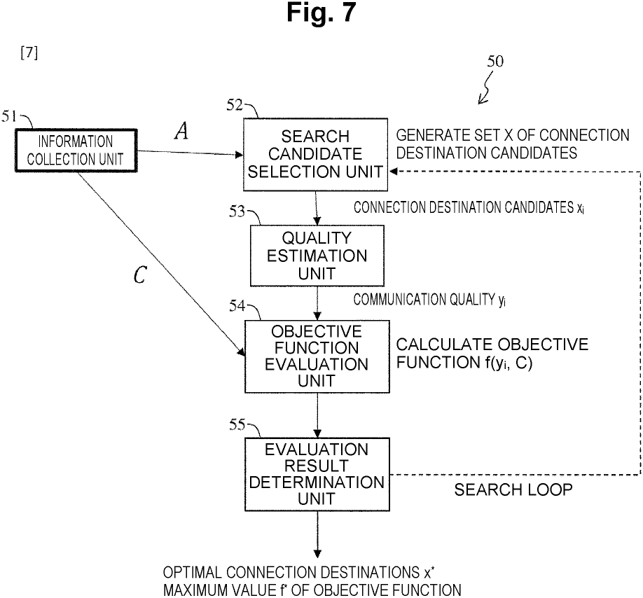

FIG. 7 is a diagram describing operation of the optimization engine 50.

A combination of NWs 12 to which the M terminals 11 are connected is represented by a vector x, and an m-th element Xₘ of the vector x indicates the number for an NW 12 to which the m-th terminal 11 is connected (1 ≤ xₘ ≤ N).

The search candidate selection unit 52 of the optimization engine 50 receives, as input, accessible access networks A that are a set of the vectors Aₘ representing NWs 12 accessible to the individual terminals 11, and generates a set X of connection destination candidates of the individual terminals.

The vector x is a vector in which the number xₘ for a connection destination NW to which each m-th terminal is connected is arrayed with respect to all terminals. In some cases, the vector x is stated as a “combination of connections”. In contrast, the vector Aₘ is a vector in which the numbers for NWs that are accessible to (are connection candidates of) the m-th terminal are arrayed.

The search candidate selection unit 52 generates the set X containing the connection destination candidates of all terminals, by using the set A of the vectors Aₘ of all terminals. Moreover, for a first time (i = 1) of the search loop, the search candidate selection unit 52 selects one connection candidate from the set X for each terminal and arrays the selected connection candidates to obtain a vector of connection destination candidates x₁, which are then inputted into the quality estimation unit 53. For each time of the search loop, the search candidate selection unit 52 changes the connection candidate of at least one terminal to obtain a new vector of connection destination candidates xᵢ. In other words, a combination of connections x is changed for each time of the search loop.

The quality estimation unit 53 receives the connection destination candidates xᵢ from the search candidate selection unit 52, and calculates communication quality yi for the terminals as a whole. The communication quality yi is a vector, and is a function (yᵢ(xᵢ)) of the connection destination candidates xᵢ. An m-th component “Y_{i,m}” of the communication quality yi is communication quality acquired at the m-th terminal in a case of a combination of connections for a time of a search loop i.

It is assumed that the objective function configured in the objective function evaluation unit 54 is “f (yi (xᵢ), C)”. It is assumed that a maximum value or a minimum value of the objective function obtained up until the i-th time of the search loop is “f*”. It is assumed that when “f*” is obtained, the then connection destination candidates are “x*”. The objective function evaluation unit 54 outputs the connection destination candidates x* by calculating a following expression by using the set C of features acquired from the information collection unit 51, the communication quality yi(xi), and the objective function.

$${x}^{*} = {arg max}_{1 \leq k \leq i} f \left({y}_{k} \left({x}_{k}\right) , C\right)$$

or (4)

$${x}^{*} = {\text{argmin}}_{1 \leq k \leq i} f \left({y}_{k} \left({x}_{k}\right) , C\right)$$

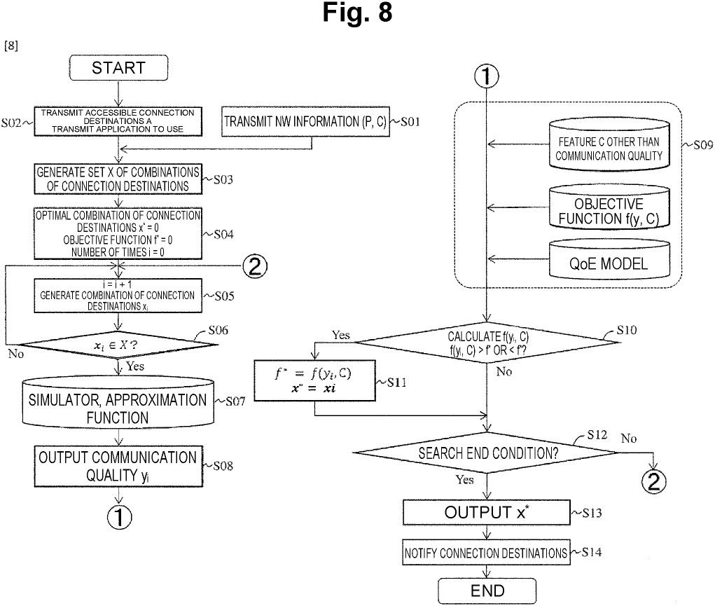

FIG. 8 is a flowchart describing operation of the communication system 301.

The network information notification unit 12b of each NW 12 notifies communication quality information (vector Pₙ) and features (vector Cₙ) other than the communication quality to the information collection unit 51 of the optimization engine 50. Note that if there is an application that can be implemented within an NW 12, the network information notification unit 12b of the NW 12 may notify a list of such an application. The information collection unit 51 generates a set P and a set C from the notified communication quality information and features.

The information notification unit 11a of each terminal 11 notifies access networks accessible at an arbitrary time point and an application that the terminal 11 is using or will use (vector Aₘ) to the information collection unit 51 of the optimization engine 50 (step S02). The information collection unit 51 generates accessible applications (set A) from the notified applications.

The notification of the information in step S01 and step S02 may be performed in any order, or may be performed at the same time. No restriction is imposed on order of the terminals or order of the networks. The above-described steps do not need to be performed, and may be preconfigured when states of the terminals and the networks are known and no dynamic changes occur.

The search candidate selection unit 52 of the optimization engine 50 generates a set X of combinations of terminal connection destinations by using the set A (step S03).

The search candidate selection unit 52 initializes the number of times i of the solution search loop, the maximum or minimum value f* of values of an objective function, and the then connection destinations x* (initial values are set to zero or a zero vector).

Step S03 and step S04 may be performed in any order, or may be performed at the same time.

The search candidate selection unit 52 of the optimization engine 50 extracts elements xᵢ from the set X of connection destination candidates. The quality estimation unit 53, by using the set P, estimates communication quality yi achieved when the elements xᵢ are used as input (steps SS05 to S08). For a method of extracting the elements xᵢ, a method of extracting elements from X at random, or a method of extracting every element in specific order may be used. A method may also be used in which elements xᵢ are generated in a random manner, and quality estimation is performed only for an element that is confirmed as satisfying “xᵢ ∈ X” (step S06).

For a method of estimating the communication quality yi (step S07), any method may be used. For example, for the method, there is a method of outputting a result of performing simulation with a system in which distributions of actual networks and users are simulated. In addition to throughput, a communication delay and the like can also be estimated by using “ns-3”, “QualNet”, “OpNet Modeler”, and any other network simulators. When it is desired to estimate only throughput, a method of performing estimation in a simplified manner may also be used, such as dividing a total bandwidth of each network by the number of people who connects to the network.

Note that as examples of the estimation method, a scheme will be described in an embodiment 2 in which the communication quality yi is estimated based on an NW simulator, or settings of an NW topology or an NW device.

The objective function evaluation unit 54, by using the preconfigured objective function f(yi, C), calculates values of the objective function from the communication quality yi obtained with respect to the elements xᵢ that are connection destination candidates and the features C other than the communication quality (step S10). For example, when the objective function f(Yᵢ, C) includes QoE (Quality of experience) representing a user satisfaction level, the objective function evaluation unit 54 uses a QoE model determined based on the application used by each terminal, which is acquired in step S02 (step S09) and derives a value of QoE from the communication quality yi and the features C. More specifically, assuming that web browsing is performed as an application, QoE can be estimated from the communication quality yi, by using a QoE model for web browsing, a bandwidth required for web pages, and an average throughput.

For an i-th time of the search loop, when the objective function f(yi, C) is larger than a maximum value f* obtained through previous searches (calculation up until an (i - 1)-th time of the search loop) (“Yes” in step S10), the evaluation result determination unit 55 updates f* to the value of the objective function f(yi, C) for the i-th time of the search loop. Moreover, the evaluation result determination unit 55 performs updating such that the elements xᵢ used when the f* is obtained become x* (step S11).

In a case of the objective function that is a function to be minimized, the evaluation result determination unit 55 updates f* when f(Yᵢ, C) is smaller than a minimum value f* obtained through previous searches (“Yes” in step S10). The evaluation result determination unit 55 performs updating such that the elements xᵢ used when the f* is obtained become x* (step S11).

The solution search loop comes to an end when a search end condition, which is “being performed as many n times as the number of elements in X” or is predetermined, is met (“Yes” in step S12). When the search end condition is not met, the search loop is repeated from step S05 (“No” in step S12).

Specifically, for the search end condition, any of the following may be used.
(1) Number of searches (an upper limit to i)
(2) Time period for search
(3) Fact that a value of a specific indicator or the objective function exceeds or falls below a certain value
(4) Fact that x* obtained in the middle of search produces a value that clearly will not be updated in the future

When the search is finished, the optimal access network notification unit 56 of the optimization engine 50 notifies a connection destination, based on x*, to at least one of the network selection unit 11b of each terminal 11 and the terminal selection unit 12a of each NW 12 (steps S13, S14). The terminals 11 and the NWs 12 having received the notification switch connection destinations in accordance with the notification. After each of the terminals 11 and the NWs 12 switches connection destinations, the terminals 11 and the NWs 12 fall in a state corresponding to x*.

### Embodiment 2

In the present embodiment, a description will be given of the scheme mentioned for step S07 in FIG. 8, in which the communication quality yi is estimated based on an NW simulator, or settings of an NW topology or an NW device.

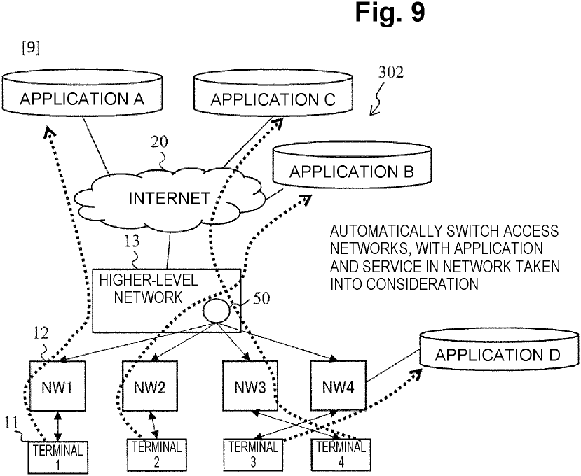

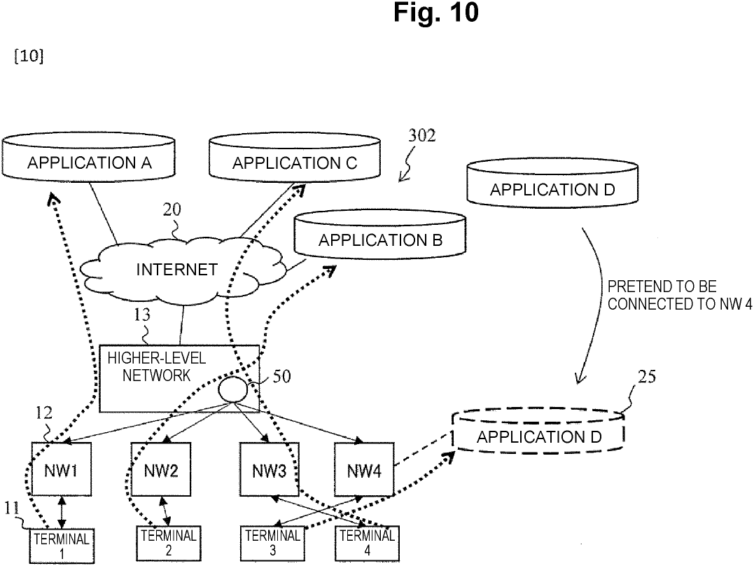

FIGS. 9 and 10 are diagrams describing a communication system 302 including an optimization engine 50 according to the present embodiment. In the communication system 302, an application server (application D) exists on a specific network (NW 12-4). The communication system 302 differs from the communication system 301 in FIG. 4 in a point that an application server exists also on an NW 12. In the present embodiment, differences of the communication system 302 from the communication system 301 will be described.

The optimization engine 50 in the communication system 302 selects means of access for a user to use, taking into consideration a fact that a communication-destination application server is installed in a specific NW. In other words, in the case of the communication system 302, a terminal 11-3 that uses the application D connects to the NW 12-4 as shown in FIG. 9, whereby restraint on lowering of quality of experience gained by the user and enhancement of the quality of experience can be achieved.

However, in a current state, the server for the application D is not connected to the NW 12-4 as shown in FIG. 10. Although the application D currently exists on the Internet, there are some cases where the application D will be connected to the NW 12-4 in the future in order to restrain lowering of quality of experience gained by a user and enhance the quality of experience. In such cases, the communication quality yi needs to be estimated by simulating a server 25 for the application D connected to the NW 12-4 by using a simulator or the like in general. However, such a scheme requires wide-ranging alterations other than an alteration to the quality estimation unit 53 of the optimization engine 50.

Accordingly, in the present embodiment, a scheme will be described that does not need alterations other than an alteration to the quality estimation unit 53 of the optimization engine 50, and that simplifies simulation settings while predicting quality with high accuracy.

In a case where there is a specific correspondence between the application D and the specific access network (NW 12-4), the quality estimation unit 53, when estimating the communication quality yi, performs processing that causes a difference in the communication quality yi, between when a terminal 11 uses the application D over the specific access network and when the terminal 11 uses the application D over the other access networks.

In other words, when step S07 in FIG. 8 is performed, the quality estimation unit 53 estimates the communication quality yi while changing an NW simulator or settings of an NW topology or an NW device. Specific changes in the settings will be described later. By changing the settings, a situation as if the server for the application D is connected to the NW 12-4, as in FIG. 10, is created, and the communication quality yi is estimated under the situation. By using the thus estimated communication quality yi in the objective function (step S10), a probability can be increased that the terminal 11-3 intending to use the application D is made to connect to the NW 12-4.

Note that existence of the application D may be preset in the optimization engine 50 by an operator, or may be received as NW information (feature C) by the information collection unit 51.

Merits of the present embodiment are as follows.

Accuracy in selection of an NW suitable for an application and a service can be enhanced, and restraint on lowering of quality of experience and enhancement of quality of experience can be achieved. Moreover, the communication quality estimation method in the embodiment 1 can be utilized as it is without making alterations (only by adding a utility function to the objective function).

### Specific Examples of the Objective Function

A setter of the objective function determines the objective function, taking into consideration a business model, user satisfaction levels, fairness, costs, or the like. Assignment of connection destinations of users can be performed based on various policies, through configuration of the objective function f(y, C).

Examples of the objective function are listed below.
(1) Total value of estimated values of satisfaction level (maximization)
$$f \left(y , C\right) = {\sum }_{m = 1}^{M} {h}_{m}$$
(P1) where hₘ is an estimated value of the satisfaction level of a user m.
(2) Number of users with estimated values of satisfaction level that are equal to or larger than a set value (maximization)
$$\begin{matrix}f \left(y , C\right) = n \left(A\right) \\ A = \left\{m \left|{h}_{m} \geq {h}_{o}\right)\right\}\end{matrix}$$
(P2) where “hₒ” is a constant.
(3) Median of estimate values of satisfaction level (maximization)
$$f \left(y , C\right) = m e d i a n \left({h}_{m}\right)$$
(P3)
(4) Variance of estimate values of satisfaction level (minimization)
$$f \left(y , C\right) = \frac{1}{M} {\sum }_{m = 1}^{M} {\left({h}_{m} - \overline{h}\right)}^{2}$$
$$\overline{h} = \frac{1}{M} {\sum }_{m = 1}^{M} {h}_{m}$$
(P4)
(5) Satisfaction level of a user with the smallest estimated value of satisfaction level (maximization)
$$f \left(y , C\right) {=}_{1 s m s m}^{\text{min}} {h}_{m}$$
(P5)
(6) Imbalance of network loading factors (minimization)
$$f \left(y , C\right) = \left|\frac{{l}_{a} - {l}_{b}}{{l}_{a} + {l}_{b}}\right|$$
(P6) where “1ₐ” and “1_{b}” are bandwidth utilization rates of access networks A and B, respectively.
Note that when three or more access networks exist, variance of respective bandwidth utilization rates lₙ of the access networks may be used (in the present expression, “n” denotes an identification number for an access network).
$$f \left(y , C\right) = \frac{1}{N} {\sum }_{n = 1}^{N} {\left({l}_{n} - \overline{l}\right)}^{2}$$
$$\overline{l} = \frac{1}{N} {\sum }_{n = 1}^{N} {l}_{n}$$
(P6a)
(7) Difference from desired allocations of network loading factor (minimization)
$$f \left(y , C\right) = \left|\frac{γ {l}_{a} - {l}_{b}}{γ {l}_{a} + {l}_{b}}\right|$$
(P7) where “y” is b/a when it is desired that 1ₐ:1_{b} is a:b. “a” and “b” are positive numbers. For example, when connection destinations are assigned such that the bandwidth utilization rates of the network A and the network B satisfies a ratio of 1ₐ:1_{b} = 3:4, a = 3, b = 4.
Note that when a plurality of (N) access networks exist, a following objective function is obtained as a result of generalizing Math. P7.
$$f \left(y , C\right) = \frac{1}{N} {\sum }_{n = 1}^{N} {\left({l}_{n} - {γ}_{n} {l}_{o}\right)}^{2}$$
(P7a) where “1₀” and “1ₙ” are bandwidth utilization rates of a reference access network and an n-th access network (n is an integer equal to or smaller than N; excluding the reference access network), respectively. “γₙ” is a value of a ratio between the bandwidth utilization rates of the reference network and the n-th network. In other words, “γₙ” is a value in a case where the bandwidth utilization rate 1₀ of the reference network and the bandwidth utilization rate 1ₙ of the n-th network satisfies 1₀:1ₙ = 1:γₙ.
(8) Total value of costs for use of circuits viewed from a mobile virtual network operator (MVNO) (minimization)
$$f \left(y , C\right) = {\sum }_{n = 1}^{N} {p}_{n} {B}_{n}$$
(P8) where pₙ is a charge for use of a circuit per band of an access network n, and Bₙ is an amount of data used per unit time over the access network n.

When the objective functions of Maths. P1, P2, P3, and P5 are configured, optimization is performed in step S10 in FIG. 8 such that the objective functions are maximized. In contrast, when the objective functions of Maths. P4, P6, P7, and P8 are configured, optimization is performed in step S10 in FIG. 8 such that the objective functions are minimized.

Moreover, the user satisfaction level used in Maths. P1 and P2 is assumed to be an indicator that takes into consideration both QoE (Quality of experience) determined by communication quality for each application, and an effect α(C) of an array Cn of features of each access network other than the communication quality. Specifically, the user satisfaction level is defined as follows.

$${h}_{m} = a \left(C\right) \times Q o E \left(y\right)$$

(P9)

When it is desired to make balanced enhancements of a plurality of objective functions f₁(y, C), f₂(y, C), ..., an objective function f(y, C) synthesized from the plurality of objective functions is configured. When different degrees of importance are placed on objective functions fⱼ(y, C), each fⱼ(y, C) can be weighted individually (j is a natural number). Hereinafter, examples of a method for synthesizing objective functions will be described. Here, a vector w is an array of proportions of weighting.

$$w = \left\{{w}_{1} , {w}_{2} , , , w j , , , \left|{Σ}_{{w}_{k}}\right) = 1\right\}$$

(5)

(A) Method using a sum for representation

$$f \left(y , C\right) = \sum {w}_{i} {f}_{i} \left(y , C\right)$$

(6)

(B) Method using a product for representation

$$f \left(y , C\right) = {\prod {f}_{i} \left(y , C\right)}^{{w}_{j}}$$

(7)

(C) Method using a sum or a product for representation after substitution by another function

When the basic objective functions represented by Maths. P1 to P8 are synthesized, the individual objective functions cannot be considered in a balanced manner with the above methods (A) and (B), in some cases. For example, when it is desired to consider an objective function to be maximized and an objective function to be minimized at the same time, synthesis needs to be performed after any one of the functions is transformed such as by inverting values. When there is a difference between ranges of possible values of the individual functions, an effect can be seen, such as an objective function with a wider range of values having more contribution. Accordingly, when it is desired to equally consider a plurality of objective functions, standardization to adjust allowable ranges is required in some cases. A function used for such transformation is configured as “g”, and an objective function f can be represented also by a synthesized function of “g” and “fⱼ”.

For example, the objective function f can be configured as follows.

$$\begin{matrix}f \left(y , C\right) = \sum {w}_{j} g \left({f}_{l} \left(y , C\right)\right) \\ f \left(y , C\right) = \prod g {\left({f}_{i} \left(y , C\right)\right)}^{{w}_{j}}\end{matrix}$$

(8)

Here, when it is desired to transform a function to be minimized into a function to be maximized, a following function may be configured.

$$g \left({f}_{i} \left(y , C\right)\right) = \frac{1}{{f}_{j} \left(y , C\right) )}$$

(9) When it is desired to transform a function to be maximized into a function to be minimized, transformation may be performed also by using a similar function.

Moreover, as an example of the function g that transforms a range of possible values, a sigmoid function of Math. 10 can also be configured. In such a case, g(fⱼ(Y, C)) ∈ [0, 1], with respect to a value of arbitrary fⱼ(y, C).

$$g \left({f}_{j} \left(y , C\right)\right) = \frac{1}{1 + \text{exp} \left(- a \left({f}_{j} \left(y , C\right)\right) - {f}_{0}\right)}$$

(10) where “a” and “f₀” are constants.

As another example of the function g, Math. 11 can also be configured. In such a case, g(fⱼ(y, C)) ∈ [0, 1], under a condition that fⱼ(y, C) ≥0.

$$g \left({f}_{j} \left(y , C\right)\right) = 1 - exp \left(\frac{{f}_{l} \left(y , C\right) - {f}_{0}}{a}\right)$$

(11) where “a” and “f₀” are constants.

When a plurality of transformations are needed, a plurality of functions gₖ and gₗ may be used at the same time. The function g ultimately used in such a case may be defined as follows.

$$g \left({f}_{j} \left(y , C\right)\right) = \left({g}_{k} {}^{∘} {g}_{l} {}^{∘} {f}_{l}\right) \left(y , C\right)$$

(12) The function g ultimately used may be a synthesized function of three or more functions.

### Specific Examples of Changing Settings

A description will be given of specific examples of the scheme of simulatively reproducing a situation in which use of an application from an external NW is restricted.

1. Case in which an application can be used over the specific NW

Method for simulative reproduction through simple settings
(i) Utilization of a firewall function
   It may be assumed on a simulator that the server for the application D exists on the Internet. By using a firewall function added to the server, the server is configured to receive only a packet from an IP address (terminal 11) in coverage of the NW 12-4. Alternatively, a similar firewall function is added to an NW device existing on a communication path from a terminal 11 to the server.
   In other words, since only a terminal in coverage of the NW 12-4 can communicate with the server and terminals in coverage of the other NWs 12 (external NWs) cannot communicate with the server, a difference is caused in the estimated communication quality yi.
(ii) Routing settings
   Static routing settings are made on a router existing on a communication path from a terminal 11 to the application D, and a packet addressed to the server for the application D received from a specified port or a specified IP address (a packet from a terminal connected to an external NW) is not forwarded, or is forwarded to another path. Conceivable examples of an installation location of a router on which the settings are made include a border between the higher-level network 13 and the Internet 20, and a location ahead of the application D. Alternatively, in the server, settings of a default gateway are made different for a specified IP address from an original path.
   In other words, since packet forwarding fails, or throughput is lowered, in routing of a packet from a terminal connected to an external NW, a difference is caused in the estimated communication quality yi.
(iii) Blocking of communication, communication through another path
   In a path from the higher-level network 13 to the server for the application D, a link with an infinitesimally small bandwidth or a sufficiently large delay is generated, and such a topology is formed that makes a communication with an IP address from an external NW travel through the link. Alternatively, forwarding at a switch or a router is configured not to be performed with sufficient quality, by setting a lower QoS value for a packet addressed to an external NW.
   In other words, since throughput or quality is lowered in forwarding of a packet from a terminal connected to an external NW, a difference is caused in the estimated communication quality yi.

2. Case of an application of which utility is enhanced in the specific NW

Method for simulative reproduction through simple settings
(i) Blocking of access from an external NW The same scheme utilizing a firewall function described above is used.
(ii) Routing settings The same scheme of making routing settings described above is used.
(iii) Lowering of quality for access from an external NW

It may be assumed on a simulator that the server for the application D exists on the Internet. An NW topology is set, or settings of a link are changed, such that access from an external NW to the server is made to travel through a communication path where a delay is larger, or to travel through a communication path with a smaller bandwidth.

In other words, since throughput in forwarding of a packet from a terminal connected to an external NW is lowered by delay insertion or bandwidth adjustment, a difference is caused in the estimated communication quality yi.

### Examples of Implementing the Optimization Engine

The above-described optimization engine 50 can also be implemented by a computer and a program, and the program can be recorded on a recording medium, and can also be provided through a network.

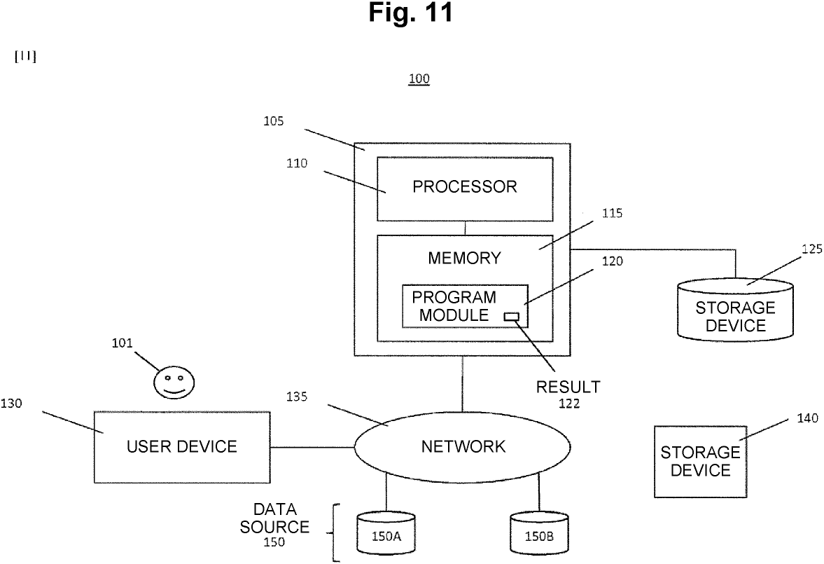

FIG. 11 shows a block diagram of a system 100. The system 100 includes a computer 105 connected to a network 135. Note that the system 100 corresponds to the communication system 301, and the computer 105 corresponds to the optimization engine 50.

The network 135 is a data communication network. The network 135 may be a private network or a public network, and can include any or all of (a) a personal area network covering, for example, a certain room, (b) a local area network covering, for example, a certain building, (c) a campus area network covering, for example, a certain campus, (d) a metropolitan area network covering, for example, a certain metropolitan area, (e) a wide area network covering regions connected across a boundary or boundaries between metropolitan areas, rural areas, or countries, and (f) the Internet. Communication is performed over the network 135 by using an electronic signal or an optical signal. Note that the network 135 corresponds to the NWs 12 and the higher-level network 13.

The computer 105 includes a processor 110 and a memory 115 connected to the processor 110. The computer 105 is illustrated as a stand-alone device in the present description but is not limited thereto, and may rather be connected to another undepicted device in a distributed processing system.

The processor 110 is an electronic device configured by using logic circuitry that responds to a command and executes the command.

The memory 115 is a tangible computer-readable storage medium in which a computer program is encoded. In this respect, the memory 115 stores data and commands, that is, program codes that are readable and executable by the processor 110 in order to control operation of the processor 110. The memory 115 can be implemented by a random access memory (RAM), a hard drive, a read-only memory (ROM), or a combination thereof. One of constituent elements of the memory 115 is a program module 120.

The program module 120 includes commands for controlling the processor 110 such that the processor 110 executes the processes described in the present description. Although it is described that the operations are performed by the computer 105, a method, processes, or lower-order processes in the present description, the operations are actually executed by the processor 110.

In the present description, the term “module” is used to refer to functional operations that can be implemented as a stand-alone constituent element or an integrated configuration including a plurality of lower-order constituent elements. Accordingly, the program module 120 can be implemented as a single module, or a plurality of modules that operate in coordination with each other. Moreover, although it is described that the program module 120 is installed into the memory 115, and is therefore implemented as software in the present description, the program module 120 can be implemented as hardware (for example, an electronic circuit), firmware, software, or a combination thereof.

Although it is illustrated that the program module 120 is already loaded onto the memory 115, the program module 120 may be configured to be located on a storage device 140 so as to be loaded onto the memory 115 later. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory, or any other type of electronic storage device that is located in an undepicted remote storage system and is connected to the computer 105 via the network 135.

The system 100 further includes a data source 150A and a data source 150B that are collectively referred to as a data source 150 in the present description and are communicably connected to the network 135. In actuality, the data source 150 can include any number of data sources, that is, one or more data sources. The data source 150 includes unsystematized data, and can include a social medium.

The system 100 further includes a user device 130 that is operated by a user 101 and is connected to the computer 105 via the network 135. For the user device 130, an input device can be cited, such as a key board or a voice recognition subsystem for enabling the user 101 to convey information and selection of a command to the processor 110. The user device 130 further includes an output device such as a display device, a printer, or a voice synthesis device. A cursor control unit such as a mouse, a trackball, or a touch-sensing screen enables the user 101 to operate a cursor on the display device in order to convey further information and selection of a command to the processor 110. Note that the user device 130 corresponds to a terminal 11.

The processor 110 outputs a result 122 of execution of the program module 120 to the user device 130. Alternatively, the processor 110 can bring the output to, for example, a database or a storage device 125 such as a memory, or alternatively, to an undepicted remote device over the network 135.

For example, a program for executing the operations in FIG. 7 may be the program module 120. The program can cause the system 100 to operate as the optimization engine 50.

The term “include ...” or “... is included” refers to presence of a characteristic, a perfect field, a process, or a constituent element that is stated there, but should be construed as not excluding presence of one or more other characteristics, perfect fields, processes, constituent elements, or a group thereof. The terms “a” and “an” are indefinite articles, and are therefore not to exclude embodiments including a plurality of things stated there.

### Other Embodiments

The present invention is not limited to the above-described embodiments, and can be carried out with various modifications made within a scope that does not depart from the gist of the present invention. In other words, the present invention is not limited to the upper embodiments as they are, and can be embodied by modifying the constituent elements within a scope that does not depart from the gist of the present invention in a stage of implementation.

Moreover, various inventions can be formed by appropriately combining the plurality of constituent elements disclosed in the above-described embodiments. For example, some constituent elements can be eliminated from all of the constituent elements shown in any of the embodiments. Moreover, constituent elements in different embodiments can be appropriately combined.

### REFERENCE SIGNS LIST

11 Terminal

11a Terminal information notification unit

11b Network selection unit

12 Access network (NW)

12a Terminal selection unit

12b Network information notification unit

13 Higher-level network

20 Internet

25 Simulated server

50 Optimization engine

51 Information collection unit

52 Search candidate selection unit

53 Quality estimation unit

54 Objective function evaluation unit

55 Evaluation result determination unit

56 Optimal network notification unit

100 System

101 User

105 Computer

110 Processor

115 Memory

120 Program module

122 Result

125 Storage device

130 User device

135 Network

140 Storage device

150 Data source

301, 302 Communication system

1. An optimization engine in a communication system, the communication system having a configuration in which each of a plurality of terminals connects to a higher-level network via any one of a plurality of access networks, the optimization engine comprising:
a processor; and
a storage medium having computer program instructions stored thereon, when executed by the processor, perform to:
collects, from each of the access networks, communication quality information and a network feature, and collects, from each of the terminals, accessibility information indicating which of the access networks is accessible;
generates, based on the accessibility information, connection destination candidates that are candidates for the access networks to which the terminals respectively connect; estimates, based on the communication quality information, communication quality with respect to the connection destination candidates to obtain estimated communication quality; and
determines optimal connection destinations from among the connection destination candidates, based on a calculated value obtained by substituting the network feature and the estimated communication quality into a preconfigured objective function, wherein in a case where there is a correspondence between an application and a specific access network over which the application can be implemented among the access networks,
, when predicting the communication quality, performs processing that causes a difference in the communication quality between when the terminal uses the application over the specific access network and when the terminal uses the application over the other access networks.

2. The optimization engine according to claim 1, wherein the computer program instructions further perform to determines that the optimal connection destinations are the connection destination candidates that give a maximum value or a minimum value of the objective function.

3. The optimization engine according to claim 1 , wherein the computer program instructions further perform to outputs a connection instruction to at least one of each of the terminals and each of the access networks such that connections between the terminals and the access networks match the optimal connection destinations.

4. An optimization method for a communication system, the communication system having a configuration in which each of a plurality of terminals connects to a higher-level network via any one of a plurality of access networks, the optimization method comprising: collecting, from each of the access networks, communication quality information and a network feature, and collecting, from each of the terminals, accessibility information indicating which of the access networks is accessible;
generating, based on the accessibility information, connection destination candidates that are candidates for the access networks to which the terminals respectively connect;
estimating, based on the communication quality information, communication quality with respect to the connection destination candidates to obtain estimated communication quality; and determining optimal connection destinations from among the connection destination candidates, based on a calculated value obtained by substituting the network feature and the estimated communication quality into a preconfigured objective function,
wherein in a case where there is a correspondence between an application and a specific access network over which the application can be implemented among the access networks,
when the communication quality is predicted, processing is performed that causes a difference in the communication quality between when the terminal uses the application over the specific access network and when the terminal uses the application over the other access networks.

5. The optimization method according to claim 4, wherein it is determined that the optimal connection destinations are the connection destination candidates that give a maximum value or a minimum value of the objective function.

6. The optimization method according to claim 4 , further comprising outputting a connection instruction to at least one of each of the terminals and each of the access networks such that connections between the terminals and the access networks match the optimal connection destinations.

7. A non-transitory computer-readable medium having computer-executable instructions that, upon execution of the instructions by a processor of a computer, cause the computer to function the optimization engine according to claim 1.
